(19) United States
(12) Patent Application Publication
(10) Pub. No.: US 2014/0340424 A1
(43) Pub. Date: Nov. 20, 2014

(54) SYSTEM AND METHOD FOR RECONFIGURABLE PROJECTED AUGMENTED/VIRTUAL REALITY APPLIANCE

(71) Applicant: Jeri J. Ellsworth, Kirkland, WA (US)

(72) Inventor: Jeri J. Ellsworth, Kirkland, WA (US)

(21) Appl. No.: 14/267,325

(22) Filed: May 1, 2014

Related U.S. Application Data
(60) Provisional application No. 61/855,536, filed on May 17, 2013.
(60) Provisional application No. 61/961,446, filed on Oct. 15, 2013.

(51) Int. Cl. G06T 11/60; G02B 27/01

(52) U.S. Cl. CPC G06T 11/60; G02B 27/0172
USPC 345/633; 359/630

(57) ABSTRACT

A system comprising a head mounted display with sight line tracking is presented with an attachment for reconfiguration from projected augmented reality applications to those using closed virtual reality as well as mixed modes.

### RELATED APPLICATIONS

The present application claims the benefit of provisional patent application No. 61/855,536 filed on May 17, 2013, entitled “Stereo 3D augmented reality display using retro-reflective screens and per eye filtering” by Jeri J. Ellsworth and No. 61/961,446 filed on Oct. 15, 2013, titled “Reconfigurable Head Mounted Display System” also by Jeri J. Ellsworth, the entire contents of which are fully incorporated by reference herein.

### U.S. PATENT DOCUMENTS

U.S. Pat. No. 3,614,314

U.S. Pat. No. 4,349,815

U.S. Pat. No. 4,657,512

U.S. Pat. No. 4,799,765

U.S. Pat. No. 5,003,300

U.S. Pat. No. 5,151,722

U.S. Pat. No. 5,162,828

U.S. Pat. No. 5,189,452

U.S. Pat. No. 5,210,626

U.S. Pat. No. 5,436,765

U.S. Pat. No. 5,467,104

U.S. Pat. No. 5,572,229

U.S. Pat. No. 5,581,271

U.S. Pat. No. 5,606,458

U.S. Pat. No. 5,621,572

U.S. Pat. No. 5,661,603

U.S. Pat. No. 5,677,795

U.S. Pat. No. 5,726,670

U.S. Pat. No. 5,742,263

U.S. Pat. No. 5,742,264

U.S. Pat. No. 6,064,749

U.S. Pat. No. 6,091,546

U.S. Pat. No. 6,147,805

U.S. Pat. No. 6,421,047

U.S. Pat. No. 6,490,095

U.S. Pat. No. 6,522,474

U.S. Pat. No. 6,532,116

U.S. Pat. No. 6,535,182

U.S. Pat. No. 6,552,854

U.S. Pat. No. 6,594,085

U.S. Pat. No. 6,611,384

U.S. Pat. No. 6,611,385

U.S. Pat. No. 6,747,611

U.S. Pat. No. 6,814,442

U.S. Pat. No. 6,825,987

U.S. Pat. No. 6,847,336

U.S. Pat. No. 6,926,429

U.S. Pat. No. 6,963,379

U.S. Pat. No. 7,031,067

U.S. Pat. No. 7,088,516

U.S. Pat. No. 7,118,212

U.S. Pat. No. 7,200,536

U.S. Pat. No. 7,242,527

U.S. Pat. No. 7,253,960

U.S. Pat. No. 7,262,919

U.S. Pat. No. 7,355,795

U.S. Pat. No. 7,391,574

U.S. Pat. No. 7,420,751

U.S. Pat. No. 7,446,943

U.S. Pat. No. 7,450,188

U.S. Pat. No. 7,450,310

U.S. Pat. No. 7,495,836

U.S. Pat. No. 7,499,217

U.S. Pat. No. 7,505,207

U.S. Pat. No. 7,538,950

U.S. Pat. No. 7,542,209

U.S. Pat. No. 7,567,385

U.S. Pat. No. 7,646,537

U.S. Pat. No. 7,724,441

U.S. Pat. No. 7,791,809

U.S. Pat. No. 7,804,507

U.S. Pat. No. 7,839,575

U.S. Pat. No. 7,843,403

U.S. Pat. No. 7,791,483

U.S. Pat. No. 7,936,519

U.S. Pat. No. 7,944,616

U.S. Pat. No. 7,982,959

U.S. Pat. No. 8,004,769

U.S. Pat. No. 8,179,604

U.S. Pat. No. 8,189,263

U.S. Pat. No. 8,194,325

U.S. Pat. No. 8,237,626

U.S. Pat. No. 8,300,159

U.S. Pat. No. 8,310,763

U.S. Pat. No. 8,328,360

U.S. Pat. No. 8,376,548

U.S. Pat. No. 8,378,924

U.S. Pat. No. 8,388,146

U.S. Pat. No. 8,433,172

U.S. Pat. No. 8,434,674

U.S. Pat. No. 8,441,734

U.S. Pat. No. 8,467,133

U.S. Pat. No. 8,472,120

U.S. Pat. No. 8,477,425

U.S. Pat. No. 8,482,859

U.S. Pat. No. 8,487,837

U.S. Pat. No. 8,488,246

U.S. Pat. No. 8,494,212

U.S. Pat. No. 8,553,334

U.S. Pat. No. 8,576,143

U.S. Pat. No. 8,576,276

U.S. Pat. No. 8,582,209

U.S. Pat. No. 8,587,612

U.S. Pat. No. 8,625,200

U.S. Pat. No. 8,632,216

U.S. Pat. No. 8,634,139

U.S. Pat. No. 8,643,951

### U.S. PATENT APPLICATIONS

2002/0041446

2004/0150884

2007/0285752

2010/0309097

2011/0037951

2011/0075357

2012/0106191

2012/0327116

2013/0042296

2013/0196757

2013/0300637

### OTHER PUBLICATIONS

“Augmented Reality Through Wearable Computing” Thad Starner, Steve Mann, Bradley Rhodes, Jeffrey Levine, 1997
“Computer Vision-Based Gesture Recognition for an Augmented Reality Interface” Moritz Stoning, Thomas B. Moeslund, Yong Liu, and Erik Granum, In 4th IASTED International Conference on Visualization, Imaging, and Image Processing, September 2004
“Constellation: a wide-range wireless motion-tracking system for augmented reality and virtual set applications” Eric Foxlin, Michael Harrington, George Pfeifer, Proceedings of the 25th annual conference on Computer graphics and interactive techniques
“Displays: Fundamentals and Applications” Rolf R. Hainich and Oliver Bimber, CRC Press 2011, ISBN 978-1-56881-439-1
“Finger tracking for interaction in augmented environments,” Dorfmuller-Ulhaas, K.; Schmalstieg, D.; Augmented Reality, 2001. Proceedings. IEEE and ACM International Symposium on, pp. 55-64, 2001
“The perceptive workbench: Computer-vision-based gesture tracking, object tracking, and 3D reconstruction for augmented desks” Thad Starner, Bastian Leibe, David Minnen, Tracy Westyn, Amy Hurst and Justin Weeks, Machine Vision and Applications, 2003, vol. 14, No. 1, pp. 59-71
“Tracking of User Position and Orientation by Stereo Measurement of Infrared Markers and Orientation Sensing,” Masaki Maeda, Takefumi Ogawa, Kisyoshi Kiyokawa, Haruo Takemura, iswc, pp. 77-84, Eighth IEEE International Symposium on Wearable Computers, Oct. 31-Nov. 3, 2004
“Wearable Virtual Tablet: Fingertip Drawing on a Portable Plane-object using an Active-Infrared Camera” Norimichi Ukita and Masatsuga Kidode, 2004, retrieved from the internet May 11, 2011

### FIELD OF THE INVENTION

This invention relates to the fields of virtual reality, augmented reality, board games and video games. More specifically this system allows multiple modes of operation from a reconfigurable head mounted display—projected images to surfaces, near to eye display and near to eye display with world image combiner for graphics overlay.

### DESCRIPTION OF THE RELATED ART

There are many examples of fixed optics head mounted display headsets, which typically consist of a display or plurality of displays and relay optics which deliver computer generated graphics to the eyes of users. Additional fixed optics may be included that combines light from the real world and allow graphics to be overlaid over that which the user views in the real world. Subsystems are often associated with these displays to track the sight line of the user so as to provide information that drives the rendering of a CGI scene for view in stereo vision, simulating 3D vision.

### SUMMARY

The invention comprises a headset or glasses that contain a display or plurality of displays with mode of primary operation, such as projected imaging, a sight line tracking subsystem and an attachment for relaying the image directly to the eyes of the user and/or world image combing optics. The sight line tracking system provides the information needed to render a stereoscopic view of a computer generated scene such as used in first person point of view based video games or simulations.

### BRIEF DESCRIPTION OF THE DRAWINGS

FIG. 1.—A typical outward projected image headset, which comprises two projection display systems and apertures for light returning to the user from surfaces in the world, together with a camera for tracking a marker.

FIG. 2.—A wired connection system for the headset in FIG. 1.

FIG. 3.—A front view of the headset in FIG. 1, showing eye alignment with projectors.

FIG. 4.—An alternate headset that relies on anisotropic reflectance.

FIG. 5.—An alternate headset that uses a single projector.

FIG. 6.—An active “marker” pad for use in sight line tracking.

FIG. 7a.—Optical paths from and back to the headset of FIG. 1.

FIG. 7b.—Optical paths from tracking marker illuminators to the headset of FIG. 1.

FIG. 8a.—Optical path for “clip on” reconfiguration to closed virtual reality mode of operation.

FIG. 8b.—Operation of hinged “flip up” to switch modes.

FIG. 8c.—Front “transparent” view of “clip on” apparatus in closed position.

FIG. 8d.—Single side application of “clip on” apparatus.

FIG. 9.—Alternate “clip on” reconfiguration for mixed real/virtual mode.

FIG. 10.—Alternate “clip on” reconfiguration with cameras for “electronic see through” mixed real/virtual mode.

### DETAILED DESCRIPTION

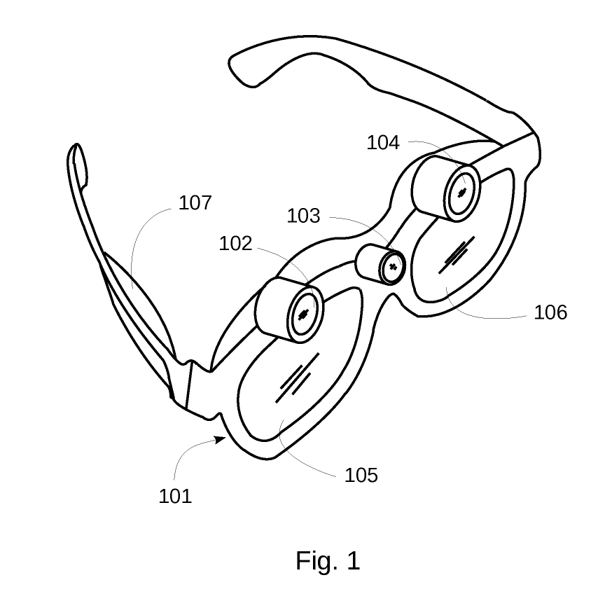

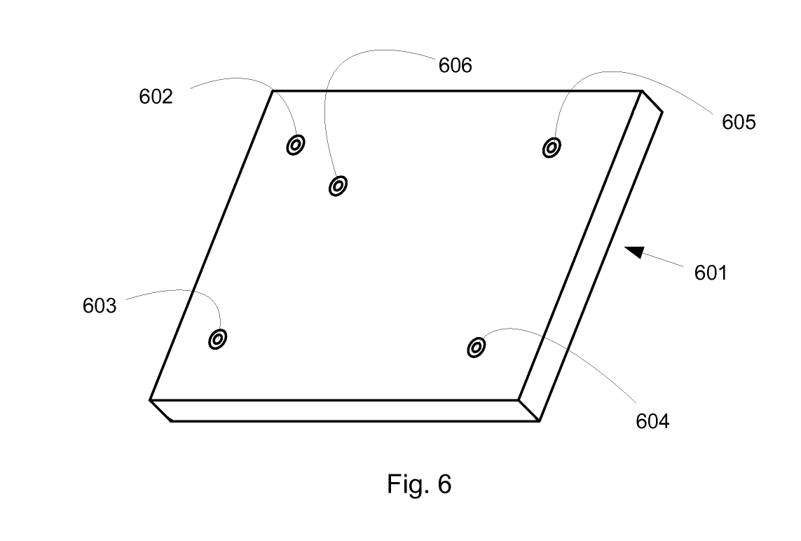

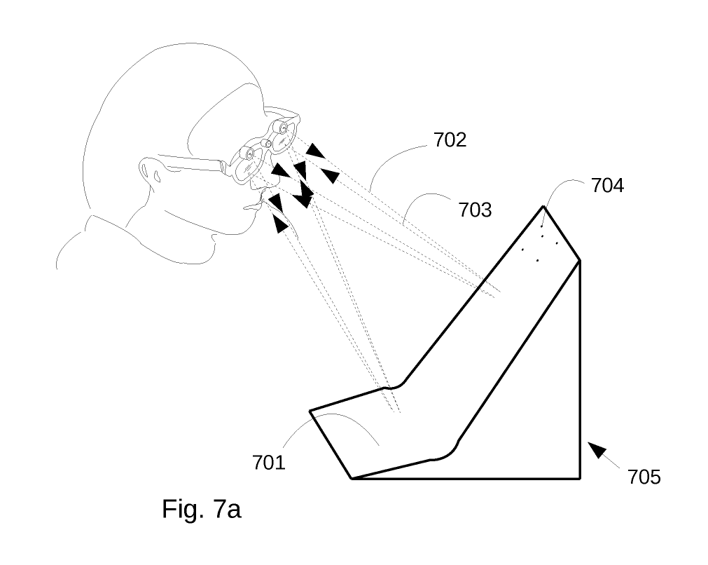

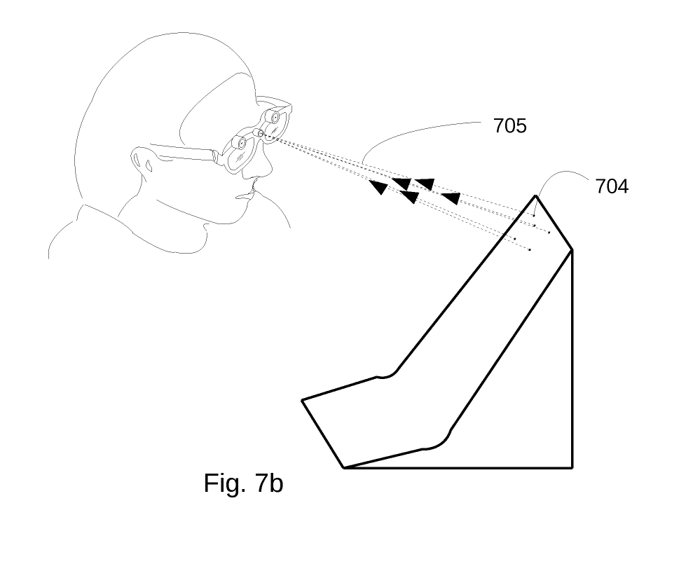

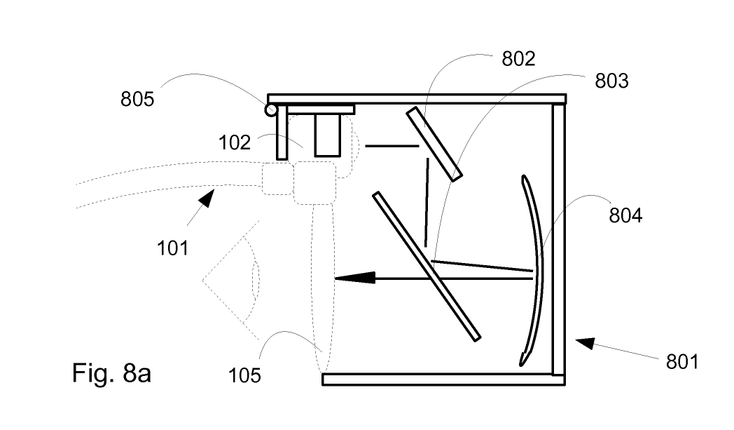

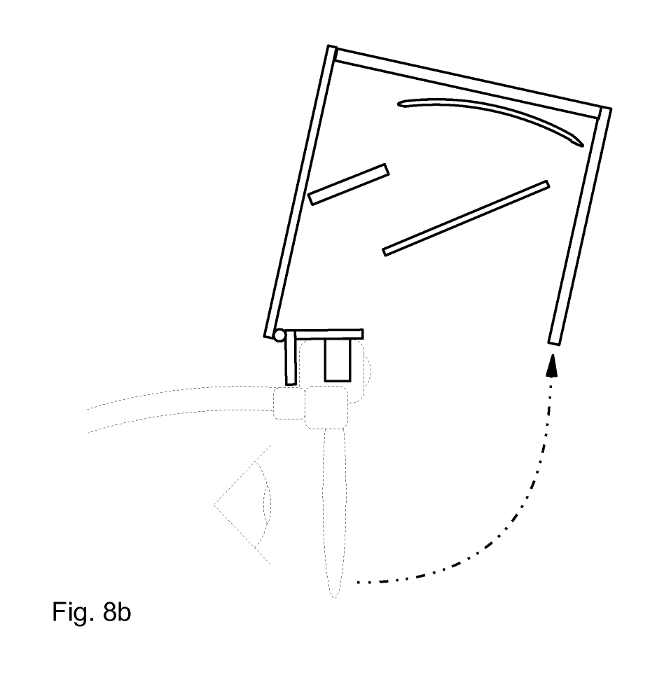

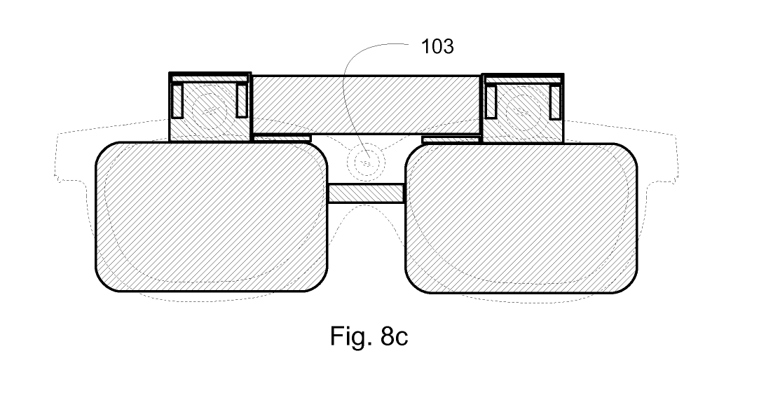

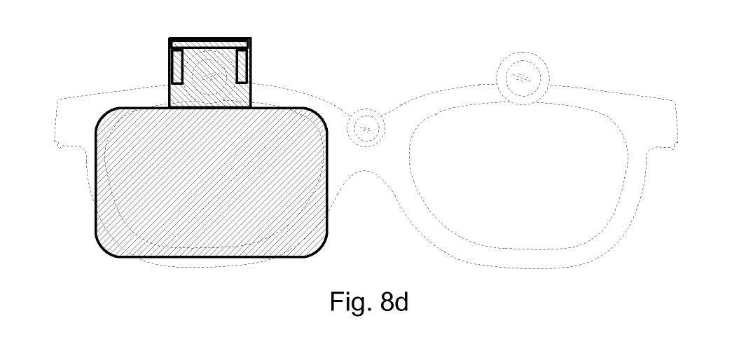

The system of the present invention comprises glasses, or headset, that contain a display or projection system (FIG. 1-5) and line of sight tracking system (FIG. 6-7) as well as a mechanically attachable relay system (FIG. 8-10) to change the mode of operation from projected to near to eye viewing.

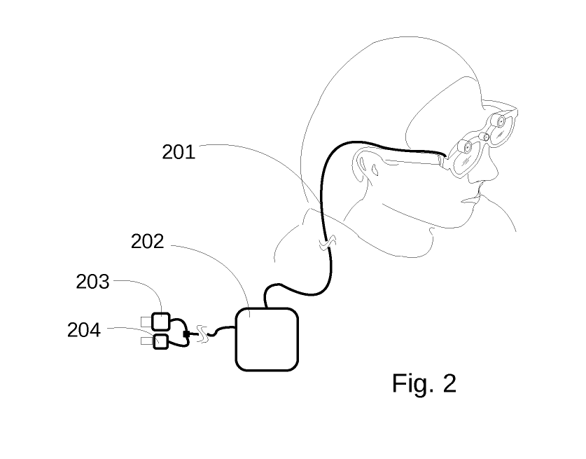

A glasses embodiment is shown in FIG. 1, in which a frame 101 supports a pair of image projectors 102 and 104, a tracking camera or cameras 103 and viewing lenses 105 and 106. A compartment is shown 107 that may hold power cells and driver electronics as well as wireless electronic communication devices. Alternately, FIG. 2 shows an embodiment with wired connections 201 to a circuit box 202 that may include connections for both a computer/cell phone interface 203 such as HDMI and/or connections for other peripherals 204 such as USB. The circuit box 202 may also include power cells.

The viewing lenses 105 and 106 in FIG. 1 provide means in conjunction with the projectors 102 and 104 to reject light that originates from the projector on the opposite side of the frame. Said means may be through selective orthogonal polarization (planer or circular), or time division multiplexed active shutters, or spectral filtering by emitter physics or software selected colors or passive filtering, or other such means known in the art.

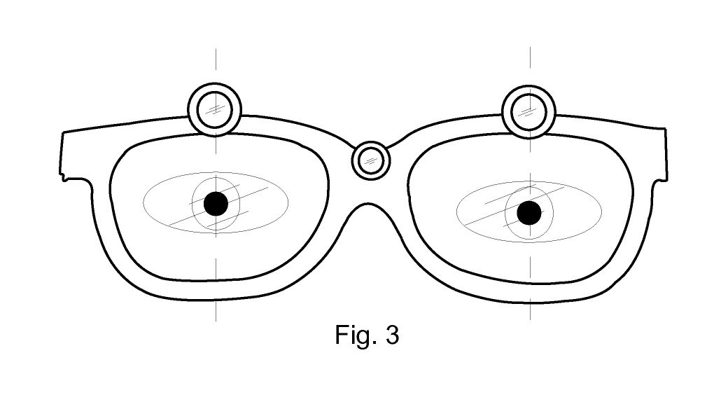

As shown in FIG. 7a, depicting the projected augmented reality mode, the system relies on a retroreflective material 701 to return the majority of light 702 emitted by the projectors 102 and 104 in path 703 to the area overlapping the viewing lenses 105 and 106. Prior art (e.g. Stanton U.S. Pat. No. 6,535,182) has taught systems in which projectors have been placed to the sides adjacent the hinges of the frame, but this carries the disadvantage that when the frames are made large enough to fit over the user's existing eyewear, the off-axis distance of the projectors from the user's eyes reduces the brightness of the returned image while trying to achieve low crosstalk of unwanted images from opposite sides. Prior art (e.g. Fisher U.S. Pat. No. 5,572,229 and Fergason U.S. Pat. No. 5,606,458) has also taught the use of beamsplitters in front of the users eyes to direct the projected light coaxial with the user sight line, which adds unwanted forward weight and extension of the frame structure. FIG. 3 shows the preferred alignment of the embodiment of FIG. 1, such that the projectors are positioned closely above the centers of each of the user's eyes, without the need for beamsplitters. It should be noted that the projectors could as well be mounted below the eyes, centered on these same center lines, and that the retroreflective material may be partially transparent such that the user can see objects placed behind it.

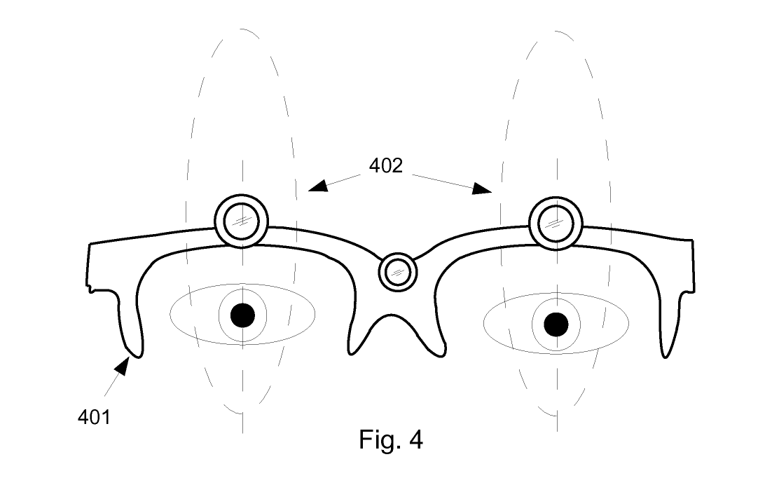

An alternate embodiment the alignment shown in FIG. 3 may be used in conjunction with an anisotropic retroreflective screen such that the pattern of returned brightness of the projected images falls off more rapidly in the horizontal direction than in the vertical direction. Anisotropic retroreflectors may be fabricated based on slightly ellipsoidal reflecting spheres that have been aligned by axis, or holographic films on mirror surfaces or other means known in the retroreflector fabrication art, and in the art of autostereoscopic screens. This form of spatial isolation of left/right images is shown in FIG. 4, where the glasses frame 401 is open without filtering viewing lenses, but rather, relies on the anisotropic bright viewing return region 402 to limit the light crossing over to the opposite eye.

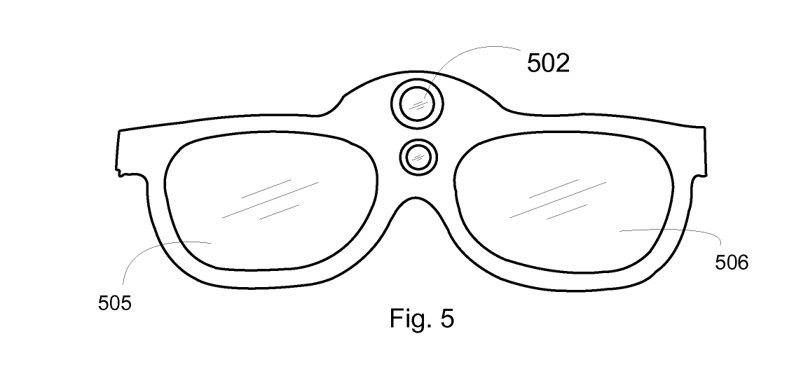

An alternate embodiment using a single projector is shown in FIG. 5, where the projector 502 sends alternate frames sequentially, and the filtering viewing lenses 505 and 506 selectively pass the left and right images to the corresponding eyes. As above, the single projector 502 may coordinate with the viewing lenses by switching polarization orthogonality (while using either planer or circular polarization), or time multiplexing by means of active shutters in the viewing lenses, or by means of projecting restricted colors re left/right sides, to be passed by spectral filters at the viewing lenses.

In order to facilitate the presentation of either virtual or advanced forms of augmented reality, it is necessary to calculate the sight line of the user. For the purposes of this specification the sight line it taken to be the line originating between the eyes of the user and extending forward parallel to the central projection lines of the projectors 102 and 104, which are mounted so as to be parallel to each other.

The sight line tracking subsystem comprises the headset camera or plurality of cameras, 103, which is mounted with central field of view line parallel to the central projection lines of 102 and 104, and a “marker” or plurality of markers that may take the form of a “pad” as shown in FIG. 6. In the current embodiment this pad or plate 601 comprises a set of five infrared light emitting diodes in which the four outer units 602-605 are in constant output mode while the offset inner diode 606 is modulated using an identifying code pattern. The power supply and modulation circuits for the emitters may be embedded in the material of the pad (not shown) or the emitters may be supplied by wire from elsewhere. The marker may also have a front surface comprising retroreflective material so as to be part of the surface returning projected images to the headset. A plurality of marker pads may be used in a given arrangement with different codes broadcast by the modulated IR source so as to be particularly identified by the headset firmware or software. Equivalent marker configurations will be apparent to designers skilled in the art.

FIG. 7a shows the typical optical paths from the projectors on the headset to a retroreflective surface 701 mounted to a frame 705. The nature of the retroreflective surface is such that the angle presented to the user is not critical and the surface may have bends, curves or flat sections. FIG. 7b shows the optical paths 705 of light originating from a marker pattern 704 of illuminators that are tracked by the camera (103 in FIG. 1) so as to provide geometric data that can be mathematically processed to calculate the user line of sight with respect to the fixed surface. In this figure the marker of FIG. 6 has been embedded into the surface 701 such that openings are provided for the IR illumination, or alternately, the surface may be transparent to IR with a marker pad behind it. For the purposes of this specification the term “retroreflector” should be taken as any surface, transparent through opaque, that returns a significant amount of projected light directly back in the direction of the projector.

The headset in FIG. 1 may be converted from projected mode to an enclosed near to eye virtual reality display by means of a “clip on” optical relay system attachment that redirects the output of the projectors to an image forming path steered directly to each of the corresponding user eyes. A cutaway diagram of the optical path of one side of the attachment is shown in FIG. 8a. In said diagram, the enclosure 801 is held in place by a clamping means to projector housing 102 on the headset frame 101 with hinge mechanism 805. The enclosure 801 contains means (not shown) to hold in place an arrangement of optical elements that steer the images generated by the projectors so as to be presented coaxial to the eyes of the user, and collimated to generate a visible image. In the shown embodiment the image from projector 102 is directed downward by mirror 802 and then forward by beamsplitter 803 and then reflected by shaped mirror 804 that provides a collimated image of correct polarization to go back through beamsplitter 803 and headset viewing lens 105. Diffractive, reflective or refractive optical elements may be placed in the optical system to change image properties. While this optical path has been described for this embodiment, many examples exist of near eye optical relay means used in the art of head mounted display, and those skilled in the art may design any number of alternate paths for this attachment.

FIG. 8b shows the attachment as “flipped up” by means of hinge 805 such that the user may switch modes without completely removing the attachment. It is anticipated that the headset will have means (not shown) to electrically or optically detect the presence and position of the attachment such that the firmware and software associated with the system may make image corrections (such as inversion) necessary to support the mode in use. It is also anticipated that mechanical means (not shown) will be included such that the user can “flip down” the attachment from the raised position with a quick nodding head movement so as to switch to enclosed virtual reality mode without removing hands from keyboards, game controllers or other equipment.

FIG. 8c shows a front view of the attachment clamped to the projectors, in the engaged position covering the face of the headset. This is drawn in x-ray style to show the headset behind it, but it should be considered as opaque. Those skilled in the art may design many other enclosures and means of attachment, such as by means of magnets or snaps or hook and loop fasteners etc., but in all designs, the fixture must not cover the camera 103, or restrict its field of view. Also nothing in this description precludes an implementation of half of the attachment, shown in FIG. 8d, such as would be used for augmented reality applications feeding closed images or information to only a single eye.

Also, it would be clear to someone skilled in the art of optical relay that an equivalent attachment can be designed for the single projector embodiment disclosed in FIG. 5. Such an embodiment might involve a beamsplitter or active beam switch that relays images laterally to each eye prior to entering a system analogous to that shown in FIG. 8a. Alternately, an optical relay may send the output of the projector to both eyes, where the unwanted frames are rejected by timed shutters or polarizing filters or spectral filters or other optical means.

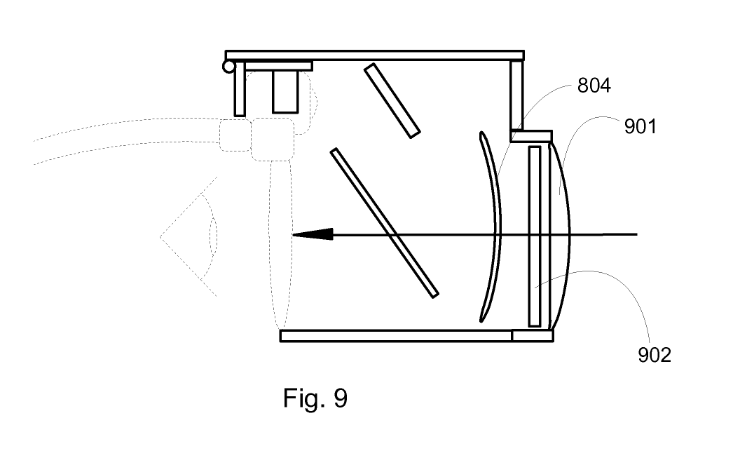

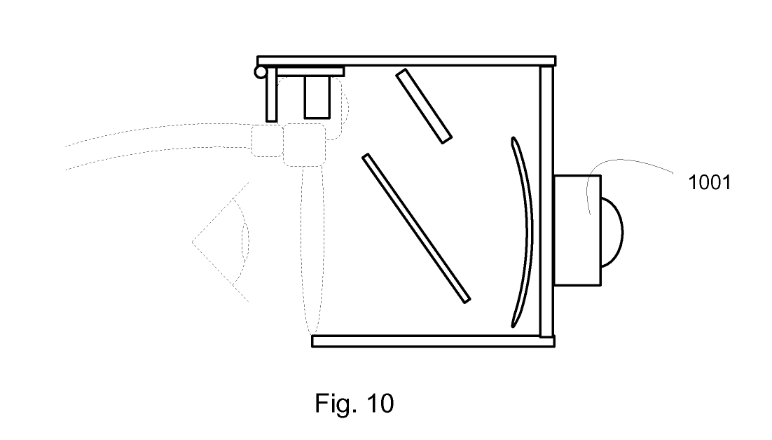

In some augmented reality applications it is desirable to mix the images generated by the computer graphics system with the actual images of the real world. In order to achieve this end, the attachment may embody a means to provide a path for light to enter from the outside world as shown in FIG. 9. In this embodiment, the enclosure is fitted with an opening and a forward facing lens or lens system 901, to gather external light and pass it through filtering means 902 and semi reflective mirror 804 before joining the coaxial optical path described above in FIG. 8a. Optics, such as field of view, anamorphic, color correction and other properties of the projection or external path, can be modified by attachments with refractive, diffractive and reflective optical elements. The filtering means 902, may include polarizers or electronic shutters, or spectral filters, or other means of masking or blocking parts of the image gathered by lens or lens system 901. Electronic means for control of said optical operations are not shown but are known to those skilled in the art. Alternately, a “see through” mode can be achieved by attaching one or more cameras 1001 to the front of the enclosure as shown in FIG. 10. In this embodiment the images of the external world are relayed electronically (not shown) to graphical mixing firmware and software (also not shown) which control the masking and substitution or overlaying of CGI images, as is well known in the art. The embodiment of FIG. 10 is particularly useful when combined with image processing software such as has been developed to track finger movements and gestures by means of images returned by video cameras.

### CONCLUSION

An illustrative embodiment has been described by way of example herein. Those skilled in the art will understand, however, that change and modifications may be made to this embodiment without departing from the true scope and spirit of the elements, products, and methods to which the embodiment is directed, which is defined by my claims.

I claim:

1. A head mounted display comprising:
a headset or glasses frame supporting one or more image projectors;
said projectors mounted closely above or below the vertical pupil center line;
one or more retroreflective surfaces;
said surfaces returning projected images to said headset;
a filtering means to reduce the brightness of unwanted images originating from said projectors mounted on opposite sides of said headset.

2. The head mounted display of claim 1, wherein said filtering means comprises:
a first polarizing filter applied to a first projector;
a second polarizing filter applied to a second projector with polarization orientation of said second filter orthogonal to that of said first polarizing filter;
a first viewing lens with polarizing filter;
said first viewing lens on the same side of said headset as said first projector;
said first polarizing filter on said first viewing lens arranged so as to reject reflected images passed through said second polarizing filter on said second projector;
a second viewing lens with polarizing filter; said second viewing lens on the same side of said headset as said second projector;
said second polarizing filter on said second viewing lens arranged so as to reject reflected images passed through said first polarizing filter on said first projector.

3. The head mounted display of claim 2, wherein the polarization type of the light projected on each side is planer.

4. The head mounted display of claim 2, wherein the polarization type of said light projected on each side is circular.

5. The head mounted display of claim 1, wherein said filtering means comprises:
a first spectral filter applied to a first projector; a second spectral filter applied to a second projector;
said second spectral filter passing parts of the visible spectrum disjoint from said first spectral filter;
a first viewing lens with spectral filter;
said first viewing lens on the same side of said headset as said first projector;
said first spectral filter at said first viewing lens arranged so as to reject reflected images passed through said second spectral filter at said second projector;
a second viewing lens with spectral filter;
said second viewing lens on the same side of said headset as said second projector;
said second spectral filter at said second viewing lens arranged so as to reject reflected images passed through said first spectral filter on said first projector.

6. The head mounted display of claim 5, wherein said spectral filtering of said projectors is by means of color selection in the encoding of the pixels of the images projected or by means of the emission spectrum of the physical illuminators employed.

7. The head mounted display of claim 1, wherein said filtering means comprises:
first and second said image projectors having alternate time slots for image projection;
first and second viewing lenses with attached or internal transparency switching means;
said switching means coordinated with said projection time slots so as to block images originating from opposite side projectors.

8. The head mounted display of claim 1, wherein said filtering means comprises:
an anisotropic retroreflective surface having long axis of anisotropy in the vertical orientation;
a vertical alignment of said projectors over or under the central position of the eye positions of said headset;
said anisotropic retroreflective having a reflective brightness pattern sufficiently narrow in the horizontal dimension so as to isolate reflected images.

9. A system comprising:
the head mounted display of claim 1;
one or more cameras mounted on said headset for receiving optical signals from a geometric array of optical emitters;
said emitters mounted in conjunction with said retroreflective surface wherein one of said emitters in said array sends a coded identification pattern.

10. The system of claim 9, wherein said emitters project infrared light.

11. The system of claim 9, further incorporating means to calculate the user sight line with regard to the said array of emitters from said optical signals.

12. A system comprising:
a projection augmented reality headset or glasses;
a removable attachment;
said attachment mountable to one side or both sides of the front of said headset;
said attachment incorporating means to reconfigure operation of said headset to that of a near eye display system.

13. The attachment of claim 12, further incorporating:
lenses for receiving images from the real world in front of the user;
means for mixing said images with images from said projectors.

14. The attachment of claim 13 further incorporating: means to mask spatial portions of said images from the real world prior to mixing with images from said projectors.

15. The attachment of claim 12 further incorporating:
a hinged mounting means;
said means facilitating the switching of operation mode of said headset by rotating said attachment in and out of the path of image projection by said headset.

16. The attachment of claim 15 further incorporating: an electrical or optical sensor;
said sensor incorporating means for providing information to the system firmware or software as to the presence and/or position of said attachment.

17. A method for displaying augmented reality comprising the steps:
projecting images from one or more head mounted image projectors;
reflecting said images back to said headset by means of one or more retroreflective surfaces;
filtering said reflected images by means selected from the set of time sequencing, polarization, spectral usage or spatial brightness pattern;
passing filtered images to selected user eyes.

18. A method for displaying virtual reality comprising the steps:
providing a head mounted projected augmented reality appliance;
attaching an optical apparatus to said appliance;
said apparatus redirecting projected images into near eye mode.

19. A method for switching the mode of operation of a head mounted display comprising the steps:
nodding of head causing the lowering of an optics apparatus without use of hands;
said apparatus redirecting projected images into near eye mode.

20. A method for tracking the sight line of a head mounted display comprising the steps:
imaging an asymmetric pattern of five or more infrared light emitting diodes with one or more high resolution electronic cameras;
fixing said pattern of emitters in position with respect to a world position;
modulating a diode among said emitters having unique position in the pattern with a unique identification code number;
encoding said modulation so as to enable demodulation by image processing of the signal from said imaging cameras;
extracting said unique identification code number from said demodulation;
looking up stored reference size and shape information related to said identification number;
solving for sight line coordinates by analyzing the image from said imaging cameras against the stored size and shape of said reference pattern.
